(19) United States
(12) Patent Application Publication
(10) Pub. No.: US 2025/0231848 A1
(43) Pub. Date: Jul. 17, 2025

(54) STATUS REPORTING IN DISTRIBUTED SYSTEMS

(71) Applicant: Cisco Technology, Inc., San Jose, CA (US)

(72) Inventors: Trevor George Smith, Bookham (GB); Marco Trinelli, Lausanne (CH); Andre Jean Marie Surcouf, Saint Leu La Foret (FR); János Sarusi-Kis, Pécel (HU); László Puskás, Balatonalmádi (HU)

(21) Appl. No.: 18/411,145

(22) Filed: Jan. 12, 2024

(51) Int. Cl. G06F 11/30; G06F 11/32

(52) U.S. Cl. CPC G06F 11/3006; G06F 11/324

(57) ABSTRACT

In an embodiment, a method for determining a state of a system is provided. The method includes organizing the plurality of nodes into a plurality of clusters, receiving by each cluster of the plurality of clusters a status request, and determining, by each cluster, after receiving the status request, a status from each node of the at least one node. The method also includes using, by each cluster, a consensus algorithm to determine a current status of a particular cluster based on the status of each of the at least one node associated with the particular cluster and reporting the current status of the particular cluster to a control plane of the system. The method further includes using, by the control plane, a second consensus algorithm to determine the state of the system based on the current status received from each cluster of the plurality of clusters and indicating to a user the determined state of the system.

### TECHNICAL FIELD

The present disclosure relates generally to a distributed cloud environment that includes a plurality of edge servers and, more particularly, to systems and methods for status reporting in distributed systems.

### BACKGROUND

Organizations in the recent past have increasingly utilized cloud environments to provide some or all their computing needs. The use of a cloud environment provided massive rewards of visibility, elasticity, agility, flexibility, scale, security, and cost-effectiveness. However, organizations have now begun to bring at least some computing back to a more local environment, such as the so-called edge computing environment. The edge computing environment that includes a plurality of edge nodes allows some computing to be performed closer to the end users or organization while still having some of the benefits of the cloud environment. The edge computing environment overcomes some of the deficiencies with cloud environments, such as bandwidth, latency, regulatory, and/or privacy concerns. However, determining the global status of the edge computing environment is not a trivial matter given the complexities of the system and the number of individual computing devices involved.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems and components depicted in the accompanying figures are not to scale, and components within the figures may be depicted not to scale with each other.

FIG. 1 illustrates a distributed computing system for performing one or more embodiments.

FIG. 2 illustrates a system architecture for performing one or more embodiments.

FIG. 3 illustrates a flow diagram of an example method for determining a state of a distributed system in accordance with at least one embodiment.

FIG. 4 illustrates a flow diagram of an example method for determining a consensus state for each of a plurality of conditions of a particular node in accordance with at least one embodiment.

FIG. 5 illustrates a computer architecture diagram shown in an illustrative computer hardware architecture in accordance with at least one embodiment.

### DESCRIPTION OF EXAMPLE EMBODIMENTS

### Overview

According to an embodiment, a method for determining a state or status of a system includes a plurality of nodes is provided. The method includes organizing the plurality of nodes into a plurality of clusters that each comprise at least one node. The method also includes receiving by each cluster of the plurality of clusters a status request and determining, by each cluster, after receiving the status request, a status that reflects a consensus state of each node. Each cluster uses, a consensus algorithm to determine the current status of a particular cluster based on the status of each node associated with the particular cluster and each cluster reports the current status of the particular cluster to a control plane of the system. The method further includes using, by the control plane, a second consensus algorithm to determine the state of the system based on the current status received from each cluster of the plurality of clusters and indicating to a user the determined state of the system

According to an embodiment, each cluster may include three or more nodes and the node may be edge nodes of a distributed computing system. The plurality of clusters may be organized into at least one workload cluster, which uses another consensus algorithm to determine a current state of a particular workload cluster based on the status of each of the clusters associated with the particular workload cluster. The current status of each workload cluster is reported to the control plane instead of the status of each of the individual clusters.

According to an embodiment of the method, the consensus state of each node is determined by determining a state of each of one or more conditions and applying a third consensus algorithm to determine a status of each node. The state of each of the one or more conditions is determined by periodically obtaining the current state of at least one condition of each node, applying a counter that is incremented each time a state change occurs in a particular condition, and setting the state of the particular condition to the current state of the particular condition when the counter is less than a threshold number after a preset amount of time. When the counter is greater than or equal to the threshold number in the preset amount of time, the particular condition is placed in an exponential back-off state for a second preset amount of time.

According to another embodiment, the disclosure describes a system that includes a plurality of nodes and a server that includes one or more processors and one or more computer-readable non-transitory storage media coupled to the one or more processors that stores instructions operable when executed by the one or more processors to cause the system to perform a method for determining a state of the system. The method for determining a state of the system includes organizing the plurality of nodes into a plurality of clusters that each comprise at least one node. The method also includes receiving by each cluster of the plurality of clusters, a status request and determining, by each cluster, after receiving the status request, a status that reflects a consensus state of each node. Each cluster uses, a consensus algorithm to determine a current status of a particular cluster based on the status of each of node associated with the particular cluster and each cluster reports the current status of the particular cluster to a control plane of the system. The method further includes using, by the control plane, a second consensus algorithm to determine the state of the system based on the current status received from each cluster of the plurality of clusters and indicating to a user the determined state of the system

According to yet another embodiment, the disclosure also describes a non-transitory computer-readable storage medium having stored therein instructions that, when executed by one or more processors, cause the one or more processors to organize a plurality of nodes into a plurality of clusters that each comprise at least one node. The instructions also cause each cluster of the plurality of clusters, to receive a status request and determine, by each cluster, after receiving the status request, a status that reflects a consensus state of each node. Each cluster uses, a consensus algorithm to determine a current status of a particular cluster based on the status of each of node associated with the particular cluster and each cluster reports the current status of the particular cluster to a control plane of the system. The control plane uses a second consensus algorithm to determine a state of a system that includes the plurality of nodes, based on the current status received from each cluster of the plurality of clusters and indicating to a user the determined state of the system.

Technical advantages of certain embodiments of this disclosure may include one or more of the following. Certain systems and methods described herein may allow for determining the status of a distributed computing system that comprises a plurality of edge nodes organized in at least a plurality of clusters. Because the state of individual conditions of each of the nodes may frequently change, determining the status of the system is not a trivial task. By using a plurality of consensus algorithms and organizing the nodes into at least clusters a more stable and accurate status is obtainable, allowing users or administrators to make better-informed decisions, while not necessarily having detailed knowledge of each of the nodes.

Other technical advantages will be readily apparent to one skilled in the art from the following figures, descriptions, and claims. Moreover, while specific advantages have been enumerated above, various embodiments may include all, some, or none of the enumerated advantages.

### EXAMPLE EMBODIMENTS

The present disclosure describes an approach that allows for efficiently determining and obtaining a consistent state for a distributed system that comprises a large number of nodes. Using a distributed system such as a distributed cloud environment with a plurality of nodes such as edge nodes allows an organization to utilize a hybrid combination of traditional cloud servers and edge nodes to provide resources and subsequently manage them as a unified system. However, while some nodes and/or subcomponents of the node have a consistent state or eventually have a consistent state, other nodes and/or sub-components of these nodes may frequently change their state to reflect current system needs and/or current availability. It is often difficult to obtain a consistent state for the entire system or even a specific group of nodes. Any time the state of a particular node changes, the state of the entire system may potentially be changed. The present disclosure seeks to address this by introducing a method for determining a consensus state for the system as well as for each level of organization of individual nodes in a distributed computing system.

The present disclosure attempts to provide a consensus state by utilizing a consensus algorithm at each level of the system to determine a consensus status for each level. The system may be organized into a hierarchy with individual nodes belonging to a cluster and individual clusters belonging to a higher-level grouping, such as a work group. By organizing the system in this way and applying a consensus algorithm at each level, the frequent changes to any single node or even sub-component of the node has little effect on the overall status of the system. A user or administrator may much more easily determine the current state or status of the system as well as where a potential problem is located without having to understand each component of the overall system. Further, any individual edge node going offline or having one or more of its components change will not cause a change in the state of the overall system, avoiding confusing or inaccurate indications of state.

The various aspects may be implemented in many different forms and should not be construed as limited to the implementations set forth herein. The disclosure encompasses variations of the embodiments as described herein. Like numbers refer to like elements throughout.

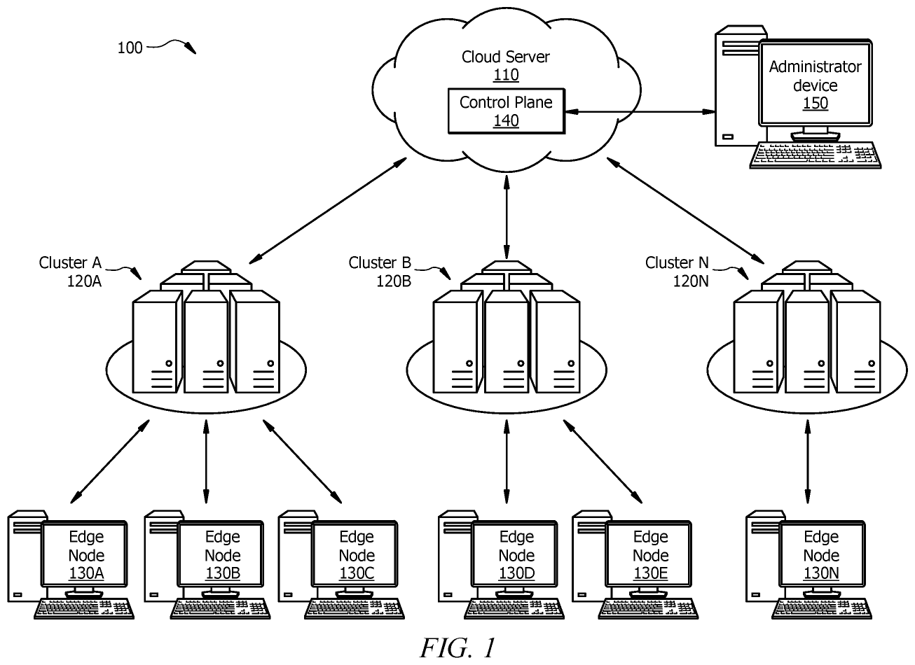

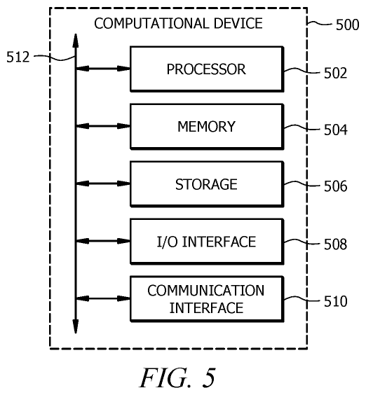

FIG. 1 illustrates a diagram of an example distributed cloud environment 100 for providing resources from one or more cloud servers 110 to a plurality of edge nodes 130A-130N that are organized or part of a plurality of clusters 120A-120N. The distributed cloud environment 100 may also include at least one administrator device 150. The distributed cloud environment 100 may include more or less devices than that shown in FIG. 1. Each of these components may be virtual, and/or one or more may be implemented by a stand-alone server or computational device configured to execute one or more stored instructions, such as those described with regards to FIG. 5.

The various devices and components of the distributed cloud environment 100 may be connected to each other using one or more networks (not shown). In some examples, the network may include devices housed or located in one or more of the edge nodes 130A-130N, the clusters 120A-120N, the administrator device 150, and/or the cloud server 110. The network(s) may include one or more networks implemented by any viable communication technology, such as wired and/or wireless modalities, and/or technologies. The network(s) may include any combination of personal area networks (PANs), local area networks (LANs), campus area networks (CANs), metropolitan area networks (MANs), extranets, intranets, the Internet, short-range wireless communication networks (e.g., ZigBee, Bluetooth, etc.), wide area networks (WANs)—both centralized and/or distributed—and/or any combination permutation, and/or aggregation thereof. The network may include devices, virtual resources, or other nodes that relay packets from one network segment to another by nodes in the computer network. The network may include multiple devices that utilize the network layer (and/or session layer, transport layer, etc.) in the OSI model for packet forwarding, and/or other layers. The network may include various hardware devices, such as routers, switches, gateways, network interfaces (NICs), application specific integrated circuits (ASICs), field-programmable gate arrays (FPGAs), servers, and/or any other type of devices. Further, the network may include virtual resources, such as virtual machines (VMs), containers, and/or other virtual resources. Additionally, or alternately, the techniques described herein are applicable to container technology, such as Docker®, Kubernetes®, and so forth.

The cloud server 110 may include one or more data centers comprising a plurality of cloud servers that are located or hosted externally by the organization. The cloud server may comprise more than one cloud server and may be provided by more than one provider, or it may be an enterprise cloud server or simply a datacenter without departing from the disclosure. The cloud server 110 may provide data storage, computing power, or other resources through interaction between one or more cloud servers, administrator devices 150, edge nodes 130A-130N, and/or client computing devices (not shown). The services hosted by the cloud server 110 are often provided on an on-demand basis and a variety of tiers of service may be provided that may be reconfigured on demand as needed. This allows the organization to have agility in responding to changing needs and to efficiently use available resources, at least from an economic and energy use perspective.

Depending on availability or capabilities, an organization may choose to use a plurality of different cloud servers to host various services/data in environments that meet geographical needs, security needs, and performance needs. In cloud environments, a unified security policy may be more easily implemented. Because of centralization, as well as scale, cloud service providers may devote resources to solving issues that many customers cannot afford and/or have the ability to implement locally. However, because the cloud server(s) 110 may be geographically located far away from the organization and because cloud installations may be complex and expensive, alternatives to the cloud environment are often needed.

One such alternative is an edge computing environment comprising one or more edge nodes 130A-130N. Edge nodes 130A-130N, much like cloud servers, include one or more datacenters, servers, and/or computing devices. However, unlike cloud servers (e.g., 110), the edge nodes 130A-130N are generally located in an organization's datacenter or in small deployments near potential customers. The one or more edge nodes 130A-130N may be physical facilities or buildings located across geographic areas that are designated to store networked services, sensors, or other computational devices. The edge nodes 130A-130N may include various networking devices, as well as redundant or backup components and infrastructure for power supply, data communications connections, environmental controls, and various security devices. The edge nodes 130A-130N may take the form of one or more computing devices as described in more detail below with regards to FIG. 5. Generally, the edge nodes 130A-130N may provide basic resources, such as processor (CPU), memory (RAM), storage (disk), and networking (bandwidth).

Because the edge nodes 130A-130N are located in an organization's own datacenters, nearer to the end users, and/or in other geographically dispersed locations, they may often provide better latency than that of third-party cloud environments, which may only have a limited number of servers providing a resource for a large geographical area. For example, there may be only one or two cloud datacenters or environments, 110 providing resources to an entire continent, while edge nodes 130A-130N might be located in each country or even in each major city. This provides better latency since the communications between client computing devices and edge nodes 130A-130N do not need to travel as far. Further, edge nodes 130A-130N often have dedicated high-speed connections to the cloud server 110 allowing for better performance and data collection than if a user device or other resource directly connects to a cloud server 110.

In one or more embodiments the edge nodes 130A-130N are controlled by a control plane 140 that may be hosted by the cloud server 110. Alternatively, or in addition, the control plane 140 may be located in one or more of the edge nodes 130A-130N, clusters 120A-120N, administrator device 150, and/or other external devices. The edge nodes may also be controlled by other means than a control plane 140, with the control plane being described and shown for simplicity.

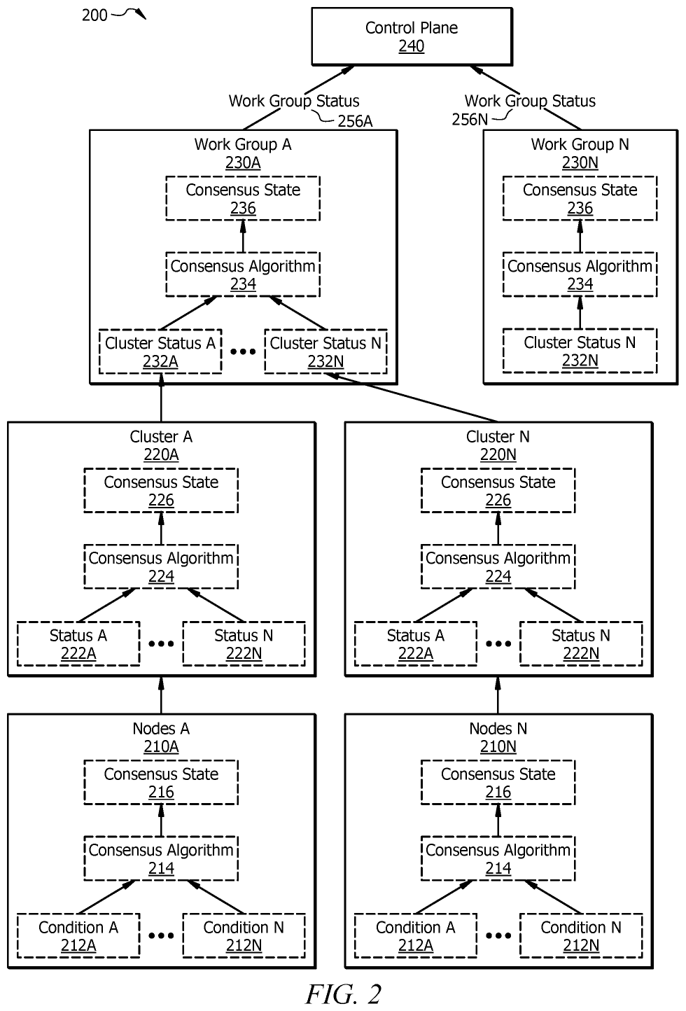

A plurality of edge nodes e.g., 130A, 130B, and 130C may be grouped in a cluster e.g., cluster A, 120A. Other edge nodes e.g., 130D and 130E may be grouped in a second cluster B 120B. Any number of edge nodes 130A-130N may be provided and grouped into any number of clusters 120A-120N or other types of groups, such as for example work groups as will be described in more detail with regards to FIG. 2. Each of these clusters 120A-120N may include one or more computational devices separate from the edge nodes 130A-130N and the cloud server 110. In certain embodiments, the clusters 120A-120N may be abstract virtual groupings of the edge nodes 130A-130N. The control plane 140 may interact only with the clusters 120A-120N or may interact with both the clusters 120A-120N and the edge nodes 130A-130N.

During the operation of the distributed cloud environment 100, one or more administrators may monitor the distributed cloud environment 100 from an administrator device 150. The administrator device 150 may be any type of computing device and may take the form of one or more computing devices as described in more detail below with regards to FIG. 5. While one administrator device 150 is shown, it may comprise a plurality of administrator devices 150 without departing from the disclosure.

The administrator device 150, in one or more embodiments, allows a user or administrator to monitor the state of the system as well as perform any other functions for configuring, maintaining, using, and/or monitoring the distributed cloud environment 100. The administrator device 150 may include a graphical user interface (GUI) for displaying the state of the system and/or status information for the various components and/or applications of the distributed cloud environment 100. The administrator device 150 may communicate with the control plane 140 of the system to determine the state and/or status of the distributed cloud environment 100, or the administrator device 150 may communicate directly with one or more of the edge nodes 130A-130N, clusters 120A-120N, and/or the cloud server 110.

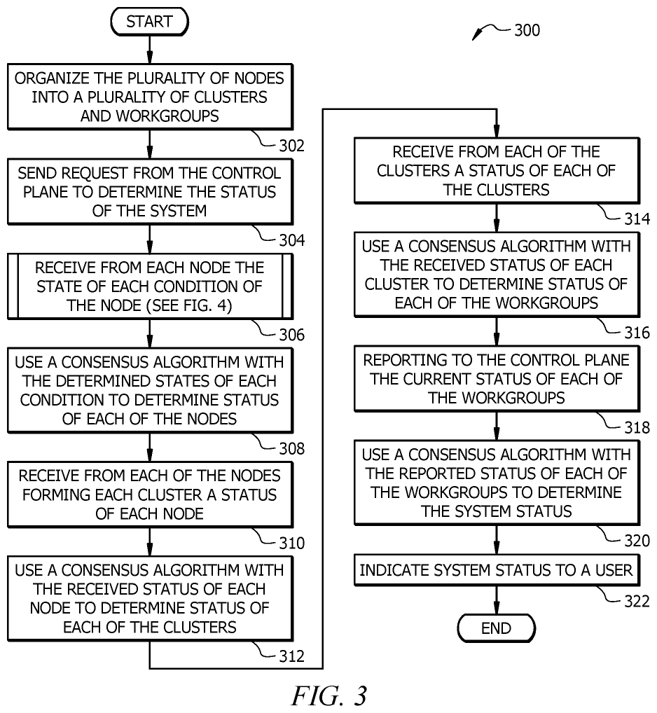

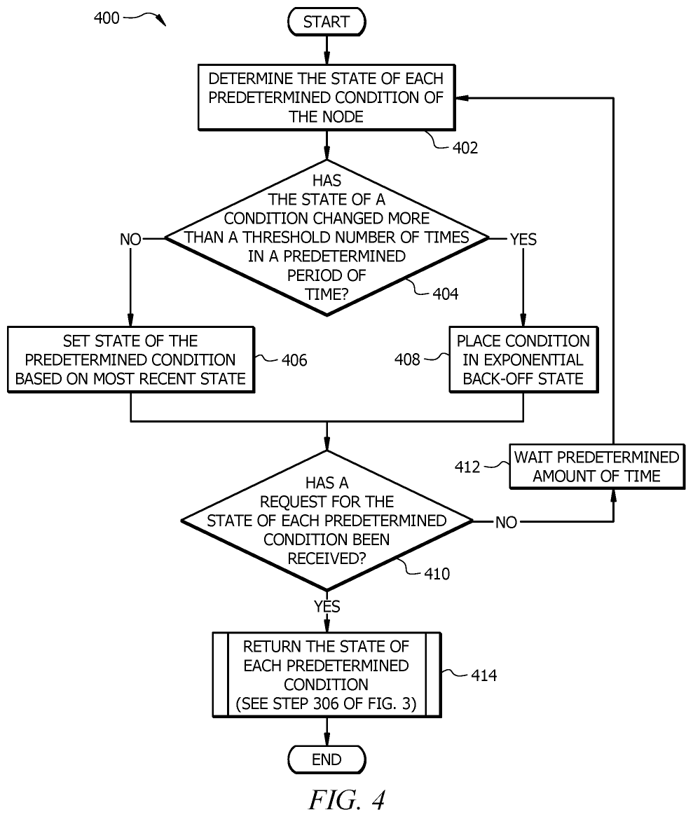

As will be described in more detail below with regards to the methods shown in FIG. 3 and FIG. 4, the control plane and/or administrator device 150 may request status information from each cluster 120A-120N and apply a consensus algorithm to determine the overall state of the cloud environment 100. In certain embodiments, each cluster 120A-120N utilizes a consensus algorithm to determine the status of each edge node 130A-130N associated with it. For example, cluster B 120B may receive status information from edge nodes 130D and 130E, and utilizing a consensus algorithm, it may report its status to the control plane 140 located on the cloud server 110. This status information may be related to the operation and functioning of the node and/or may be related to the status of applications hosted and/or used by the node. The control plane receives similar status information from cluster A 120A as well as any other clusters (e.g., cluster N, 120N). This status information is combined by the control plane 140 using a second consensus algorithm to determine the overall system state which is then displayed on the administrator device 150.

FIG. 2 shows an exemplary mapping 200 in accordance with at least one embodiment. The mapping 200 shows one exemplary grouping of nodes 210A-210N, clusters 220A-220N, and workgroups 230A-230N and the status signaling and/or messaging between these components and the control plane 240. Each of these components may take the form of the components described above with regards to FIG. 1, or any of the components or all of the components described in FIG. 2 may be different than those shown in FIG. 1. Each of the nodes 210A-210N may take the form of a finite state machine and/or may comprise of one or more edge devices such as the edge nodes 130A-130N shown in FIG. 1.

The mapping shows how the status is obtained from individual conditions 212A-212N of each node 210A and combined together to determine a system status by the control plane 240 as is described in more detail in the methods shown in FIG. 3 and FIG. 4. The mapping may include any number of nodes 210A-210N with two nodes being shown in FIG. 2 only for simplicity. Each node 210A-210N may have one or more conditions 212A-212N that are monitored to determine the overall state of the node 210A. Each node, e.g., 210A, may include only one condition, e.g., 212A, or may include any number of conditions 212A-212N, depending on the specific structure of the node, e.g., 210A, purpose, and/or particular application(s) being hosted by each node 210A-210N. Different nodes, e.g., 210N, may have more or less conditions 212A-212N than other nodes, e.g., 210A, and each condition 212A-212N, may have one or more sub-conditions without departing from the disclosure. Two conditions 212A-212N are shown for each node 210A-210N only for purposes of illustration, and the disclosure is not limited to only two conditions.

In one or more embodiments the status or state of each node 210A-210N is determined by obtaining a status of each condition 212A-212N associated with a particular node 210A. The status may be something as simple as on or off; initializing, ready, or failed; or it may be a more complex state or status that indicates various transitional stages or operational capabilities of a particular condition, e.g., 212A. The status may also, or alternatively, be related to the status of a particular application or applications hosted by the node or utilized by the node. The status of the node may be related to any applications, conditions, or other criteria related to the nodes and the applications hosted by them without departing from the disclosure.

The status or state of each condition 212A-212N is periodically monitored. As will be described in more detail with regards to the method shown in FIG. 4, when the status of a particular condition, e.g., 212A, changes more often than a predetermined amount during a preset time the status may be changed to be an exponential back-off and not considered again for a second preset amount of time. The status of exponential back-off in one or more embodiments may be equivalent to failed or initializing depending on the specific node 210A-210N and/or user or administrator preferences. The preset amount of time and/or the second preset amount of time may be any useful amount of time, such as, but not limited to a millisecond, ten milliseconds, a second, ten seconds, a minute, etc. Further, the predetermined amount may be any useful amount determined, along with the first and second preset amounts of time, by a user, administrator, developer, device manufacturer, or other concerned party.

If the particular condition, e.g., 212, does not change more often than the predetermined amount or the condition is placed in an exponential back-off status, the status of the condition is reported as being the most recent status of the condition, or the status may be that which is most frequent or selected based on other criteria as appropriate. Each status from the plurality of conditions 212A-212N that are associated with a particular node 210A are collected and one or more consensus algorithms 214 are applied to determine a consensus state 216 for the particular node, e.g., 210A. The dampening algorithm may take any common form and may be used to determine a state of each condition 212A, as well as determine the consensus state 216 by resolving each condition to a particular state and determining the overall state of the particular node, e.g., 210A. The overall consensus state 216 may be determined by averaging, either weighted or unweighted, the states of the conditions 212A-212N, or may be obtained by other means dependent on the specific use and/or configuration of the particular node 210A.

Once a consensus state 216 is determined for a particular node, e.g., 210A, periodically or after a user or administrator requests a system status, the consensus state 216 for each node e.g., 210A, associated with a cluster, e.g., cluster A 220A, is transmitted or gathered by the particular cluster A 220A as one or more statuses 222A-222N. As described above, each cluster 220A-220N may be associated with at least one node 201A-210N, and each cluster 220A-220N will receive at least one status 222A-222N for each node 210A-210N that is associated with it. For example, in a non-limiting example, if cluster A 220A is associated with three nodes 210A-210N, it will receive three statuses 222A-222N. Each cluster 220A-220N may be associated with more or less nodes 210A-210N without departing from the disclosure.

Once a particular cluster, e.g., 220A, receives a status 222A-222N from each associated node 210A-210N, the cluster will apply a consensus algorithm 224 to those statuses and determine a consensus state 226. The consensus algorithm 224 may be the same as consensus algorithm 214 or may be different depending on if all the nodes 210A-210N associated with a particular cluster e.g., 220A have the same conditions 212A-212N, have the same level of stability, and/or if the conditions 212A-212N for each particular node, e.g., 210A associated with the particular cluster, e.g., 220A, have differences. If the conditions 212A-212N for each particular node, e.g., 210A, associated with the particular cluster, e.g., 220A, have differences, then the consensus algorithm 224 may be different to consider the differences in the individual nodes 210A-210N associated with the particular cluster 220A. Once a consensus state for the particular cluster, e.g., 220A, is determined, that consensus state is either transmitted to the control plane 240 or in one or more embodiments to a work group 230A-230N.

In one or more embodiments, a plurality of clusters 220A-220N may be further grouped together as a work group, e.g., 230A, or other groupings. These work groups 230A-230N may obtain cluster statuses 232A-232N from each cluster 220A-220N that is associated with the work group 230A and use a third consensus algorithm 234 to obtain a consensus state 236 for the particular work group 230A, this consensus state along with the consensus state 236 of any other work groups 230N are then provided or transmitted as workgroup status 256A-256N to the control plane 240, which may use yet another consensus algorithm to determine an overall system state. The system may have more or less groupings than shown in FIG. 2 and may have an organization that is different than the hierarchical organization shown in FIG. 2 Other criteria may be used to determine a system's state or status, and the disclosure is not limited to what has just been described.

FIG. 3 illustrates an exemplary method 300 for determining a system status and optionally indicating it to a user, in accordance with one or more embodiments. In one or more embodiments, method 300 is performed by a distributed cloud environment 100 as shown and described above with regards to FIG. 1. In certain embodiments, method 300 may be performed by any system comprising a plurality of nodes and is not limited to that shown in FIG. 1 and/or FIG. 2.

At step 302, in one or more embodiments, a plurality of nodes, such as edge nodes 210A-210N, are organized into a plurality of clusters 220A-220N and optionally workgroups, as shown, for example, in FIG. 1 and FIG. 2. More or less groupings may be used and organizing the clusters into workgroups is optional in one or more embodiments depending on the size and complexity of the distributed cloud environment 100.

Once the nodes 210A-210N are organized in step 302, at some time later or periodically a request is sent from the control plane 240 to determine the status of the system in step 304. This status may be the overall state of the distributed cloud environment 100 or may be a status related to specific groupings or even specific nodes 130A-130N. In one or more other embodiments, the request may be sent from other components of the distributed cloud environment 100, and the disclosure is not limited to having the control plane 240 initiate determining the system status.

When the request sent in step 304 is received, each of the nodes 210A-210N determines a state of each condition 212A-212N associated with the particular node, e.g., 210A, in step 306. This may be done by using one or more dampening algorithms. In one or more embodiments, this dampening algorithm is performed using the method described below and shown in FIG. 4. The state of each condition may be ascertained in a different manner than what is shown in FIG. 4, and the method of FIG. 3 is not limited to receiving the condition from the node 210A-210N in the manner described below with regards to FIG. 4.

Once the state of each condition of a particular node 210A-210N is received in step 306, the method proceeds to step 308 where a dampening algorithm is applied to each condition 212A-212N of the nodes 210A-210N to determine a consistent state for each condition 212A-212N and then using the consistent state of each condition, a determined overall status of the node, e.g., 210A, is determined based by using a consensus algorithm 214 specific to the node, e.g., 210A.

For example, where all conditions 212A-212N must be ready for the node, e.g., 210A, to be considered ready the algorithm determines from the consistent state of each condition 212A-212N if they are all ready. If one is not, then the status is set as failed or initializing as appropriate. In other examples with different algorithms and/or nodes, an average of the consistent states may be used, or a particular state may be chosen based on statistically relevant criteria such as, but not limited to, a predetermined number of the conditions 212A-212N and/or sub-conditions having the same state.

Once an overall or consensus state 216 of each node 210A-210N is determined in step 308, each cluster 220A-220N receives from each node 210A-210N associated with the cluster, e.g., 220A, a node status 222A-222N in step 310. These statuses 222A-222N are then taken in step 312 and used with an appropriate consensus algorithm 224 to determine the status of the cluster, e.g., 220A. This consensus algorithm 224 may be similar to the consensus algorithm 214 that is used in step 308 to determine the status of each node 210A-210N or a different algorithm. For example, where all the nodes 210A-210N must be ready for the cluster 220A-220N to be considered ready, the consensus algorithm 224 determines from the consistent status of each node 210A-210N if they are all ready, if one is not, then the consensus state 226 of the cluster 220A is set as failed or initializing as appropriate. In other examples with different algorithms and/or nodes, an average of the consistent states 216 of each node 210A-210N may be used or a particular status 222A-222N may be chosen based on statistically relevant criteria such as, but not limited to, a predetermined number of the nodes 210A-210N having the same status 222A-222N.

Once a status or consensus state 226 for each cluster 220A-220N is determined in step 312, the method either proceeds to step 314 where optionally a work group 230A associated with the cluster 220A-220N receives the statuses 232A-232N for each of the clusters 220A-220N associated with it, or the method proceeds to step 318 where the control plane 240 receives the status of each cluster 220A-220N. When the particular distributed cloud environment 100 is only organized into nodes 210A-210N and clusters 220A-22ON the method then may proceed to step 320. Optionally, the method may proceed to step 314 when the clusters 220A-220N are organized into work groups 230A-230N.

At step 314, each workgroup 230A-230N receives from each cluster, e.g., 220A, associated with it, a cluster status, e.g., 232A. These cluster statuses 232A-232N are then used in step 316 by an appropriate consensus algorithm 234 to determine the consensus state 236 of the workgroup, e.g., 230A. This consensus algorithm 234 may be similar or the same as the consensus algorithm 224 and 214 used in either step 308 or step 312, or a different algorithm.

Once the status or consensus state 236 of each workgroup 230A-230N is determined in step 316, the statuses 256A-256N of the working groups 230A-230N are received by the control plane 240 in step 318. The control plane 240 then uses an appropriate consensus algorithm similar, but not necessarily the same, to that used in steps 312 and 316 to determine the state of the system. Additionally, a dampening algorithm may be used in each of steps 312, 316, and 320 where the individual states of the nodes, clusters, and work groups, change frequently. Once the system state is determined, this state along with any other useful information may be indicated to a user in step 322. The method 300 may end after step 322.

Although this disclosure describes and illustrates particular steps of method 300 of FIG. 3 as occurring in a particular order, this disclosure contemplates any suitable steps of method 300 of FIG. 3 occurring in any suitable order. Although this disclosure describes and illustrates an example method for determining a system status and optionally indicating it to a user including the particular steps of the method of FIG. 3, this disclosure contemplates any suitable method for determining a system status and optionally indicating it to a user including any suitable steps, which may include all, some, or none of the steps of the method of FIG. 3, where appropriate. Although FIG. 3 describes and illustrates particular components, devices, or systems carrying out particular actions, this disclosure contemplates any suitable combination of any suitable components, devices, or systems carrying out any suitable actions.

FIG. 4 illustrates an exemplary method 400 for determining a state of each condition 212A-212N of a node 210A-210N, in accordance with one or more embodiments. In one or more embodiments, method 400 is a dampening algorithm that is performed as part of step 306 of FIG. 3. However, method 400 may be a stand-alone method and may be performed with or without some or all of the steps shown in FIG. 3. Method 400 may be performed in a distributed cloud environment 100, as shown and described above, with regards to FIG. 1 and FIG. 2, or method 400 may be performed by any computational system and is not limited to that shown in FIG. 1 and/or FIG. 2.

At step 402, in one or more embodiments, the state of each condition 212A-212N and/or sub-condition of a node, e.g., 210A, is determined. These conditions 212A-212N may be associated with the overall functioning of the node, e.g., 210A, or with conditions of the software, hardware, or other components that make up the node and/or may be related to such things as network connectivity, power, sensor gathering, or other states that may be measured. The state of each component may be determined periodically based on a predetermined time frame set by a user, administrator, developer, or other concerned party, and may include determining the state every millisecond or faster, every second, every day, or any other appropriate time period for the specific condition 212A-212N and/or node 210A-210N.

In one or more embodiments, a counter that is incremented is applied to each condition 212A-212N or sub-condition of a node, e.g., 210A. The counter is incremented each time a state change occurs in a particular condition, e.g., 212A, or sub-condition. This number is stored and used in step 404.

Once the state of each predetermined condition 212A-212N is determined in step 402, the method proceeds to step 404. In step 404, a determination is made if the state of any individual condition, e.g., 212A, has changed more than a threshold number of times in a predetermined period of time as indicated by a counter. The threshold number and predetermined period of time may be any appropriate number and time that may indicate that a particular condition's state has not resolved and/or become consistent. For example, in a non-limiting example, if the predetermined period of time is one second, and the state changes more than a threshold of ten times over that second, this may indicate that the condition is not consistent. Other periods of time and/or number of changes may be used without departing from the disclosure.

If it is determined in step 404 that the state has not changed as indicated by the counter more than the threshold number of times in the predetermined period of time, the method proceeds to step 406. In step 406, the state of the predetermined condition is set to the most recent state. In one or more other embodiments, the state may be set to the average state or be set based on any other criteria chosen by a user or administrator.

If in step 404 it is determined that the counter is greater than or equal to a threshold number, the method proceeds to step 408. In step 408 the condition is placed in an exponential back-off state, and the state is not changed for a second period of time determined by a user, administrator, developer, and/or manufacturer. For example, using the previous example; the condition may be put in an exponential back-off state for ten seconds to allow it to resolve, during those ten seconds, the state of the condition will be reported as an exponential back-off state, a failed, or another appropriate state. Once those ten seconds pass a new state for the condition may be determined, as will be described in steps 410 and 412.

Once the condition is placed in its most recent state in step 406 or an exponential back-off state in step 408, the method proceeds to step 410, where it is determined if a request for the state of each predetermined condition and/or the node has been received. If a request has not been received, the method proceeds to step 412 where the method waits a predetermined period of time before returning to step 402. The predetermined period of time that the method waits in step 412 may be anywhere from zero microseconds to days or weeks depending on the specific configuration of the system and the needs of the users of the system.

If in step 410 it is determined that a request for the state of each predetermined condition and/or the node has been received, the method proceeds to step 414, where the state of each predetermined condition is returned, for example, in step 306 of FIG. 3. The method may end after step 414.

Although this disclosure describes and illustrates particular steps of method 400 of FIG. 4 as occurring in a particular order, this disclosure contemplates any suitable steps of method 400 of FIG. 4 occurring in any suitable order. Although this disclosure describes and illustrates an example method for determining a state of each condition of a node including the particular steps of the method of FIG. 4, this disclosure contemplates any suitable method for determining a state of each condition of a node including any suitable steps, which may include all, some, or none of the steps of the method of FIG. 4, where appropriate. Although FIG. 4 describes and illustrates particular components, devices, or systems carrying out particular actions, this disclosure contemplates any suitable combination of any suitable components, devices, or systems carrying out any suitable actions.

FIG. 5 shows an example computer architecture for a computational device 500 capable of executing program components for implementing the functionality described above. The computer architecture shown in FIG. 5 illustrates any type of computational device 500, such as a conventional server computer, workstation, desktop computer, laptop, tablet, network appliance, e-reader, smartphone, or other computing device, and may be utilized to execute any of the software components presented herein. The computational device 500 may, in some examples, correspond to any of the devices, such as the edge nodes 130A-130N, and administrator device 150, as well as components of the cloud server 110 and clusters 120A-120N as shown in FIG. 1, and/or any other device described herein, and may comprise personal devices (e.g., smartphones, tablets, wearable devices, and laptop devices), networked devices, such as servers, switches, routers, hubs, bridges, gateways, modems, repeaters, access points, and/or any other type of computing device that may be running any type of software and/or virtualization technology.

In particular embodiments, one or more computational devices 500 perform one or more steps of one or more methods described or illustrated herein, such as the methods described with respect to FIG. 3 and FIG. 4. In particular embodiments, one or more computational devices 500 provide the functionality described or illustrated herein, such as the functionality described with respect to FIGS. 1-4. In particular embodiments, software running on one or computational device 500 performs one or more steps of one or more methods described or illustrated herein or provides functionality described or illustrated herein. Particular embodiments include one or more portions of one or more computational devices 500.

Particular embodiments may include any suitable number of computational devices 500. Computational device 500 may take any suitable physical form. As example and not by way of limitation, computational device 500 may comprise an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computational device 500 may include one or more computational devices 500; be unitary or distributed; span multiple locations; span multiple machines; span multiple data centers; or reside in a cloud, which may include one or more cloud components in one or more networks.

Where appropriate, one or more computational devices 500 may perform without substantial spatial or temporal limitation one or more steps of one or more methods described or illustrated herein. As an example, and not by way of limitation, one or more computational devices 500 may perform in real-time or in batch mode one or more steps of one or more methods described or illustrated herein. One or more computational devices 500 may perform at different times or at different locations one or more steps of one or more methods described or illustrated herein, where appropriate.

In particular embodiments, computational device 500 includes a processor 502, memory 504, storage 506, an input/output (I/O) interface 508, a communication interface 510, and a bus 512. Although this disclosure describes and illustrates a particular computational device or node having a particular number of particular components in a particular arrangement, particular embodiments may include any suitable computer system having any suitable number of any suitable components in any suitable arrangement.

In particular embodiments, processor 502 includes hardware for executing instructions, such as those making up a computer program. As an example, and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. Processor 502 may include any suitable number of any suitable internal caches, where appropriate.

As an example, and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual address translation for processor 502.

In particular embodiments, processor 502 may include one or more internal registers for data, instructions, or addresses. Processor 502 may include any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, particular embodiments may include any suitable processor.

In particular embodiments, memory 504 includes main memory for storing instructions for processor 502 to execute or data for processor 502 to operate on. As an example, and not by way of limitation, computational device 500 may load instructions from storage 506 or another source (such as, for example, another computational device 500) to memory 504. Processor 502 may then load the instructions from memory 504 to an internal register or internal cache.

To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere).

One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate access to memory 504 requested by processor 502. In particular embodiments, memory 504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. Particular embodiments may include any suitable RAM. Memory 504 may include one or more memories 504, where appropriate. Although this disclosure describes and illustrates a particular memory, particular embodiments may include any suitable memory.

In particular embodiments, storage 506 includes mass storage for data or instructions. As an example, and not by way of limitation, storage 506 may include a hard disk drive (HDD), a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to the computational device 500, where appropriate. In particular embodiments, storage 506 is a non-volatile, solid-state memory. In particular embodiments, storage 506 includes read-only memory (ROM). Where appropriate, this ROM may be mask-programmed ROM, programmable ROM (PROM), crasable PROM (EPROM), electrically crasable PROM (EEPROM), electrically alterable ROM (EAROM), flash memory, or a combination of two or more of these. Storage 506 may take any suitable physical form.

Storage 506 may include one or more storage control units facilitating communication between processor 502 and storage 506, where appropriate. Where appropriate, storage 506 may include one or more storages 506. Although this disclosure describes and illustrates particular storage, particular embodiments may include any suitable storage.

In particular embodiments, I/O interface 508 includes hardware, software, or both, providing one or more interfaces for communication between a computational device 500 and one or more I/O devices. Computational device 500 may include one or more of these I/O devices, where appropriate. One or more of these I/O devices may enable communication between a person and computational device 500. As an example, and not by way of limitation, an I/O device may include a keyboard, keypad, microphone, monitor, mouse, printer, scanner, speaker, still camera, stylus, tablet, touch screen, trackball, video camera, another suitable I/O device, or a combination of two or more of these. An I/O device may include one or more sensors. Particular embodiments may include any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, particular embodiments may include any suitable I/O interface. In particular embodiments, I/O interface 508 may include an interface to a remote network management system.

In particular embodiments, communication interface 510 includes hardware, software, or both providing one or more interfaces for communication (such as, for example, packet-based communication) between computational device 500 and one or more other computational devices 500 or one or more networks. As an example, and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network.

Particular embodiments may include any suitable network and any suitable communication interface 510 for it. As an example, and not by way of limitation, computational device 500 may communicate with an ad hoc network, a personal area network (PAN), a LAN, WAN, MAN, or one or more portions of the Internet or a combination of two or more of these. One or more portions of one or more of these networks may be wired or wireless. As an example, computational device 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network, a Long-Term Evolution (LTE) network, or a 5G network), or other suitable wireless network or a combination of two or more of these. Computational device 500 may include any suitable communication interface 510 for any of these networks, where appropriate. Communication interface 510 may include one or more communication interfaces 510, where appropriate. Although this disclosure describes and illustrates a particular communication interface, particular embodiments may include any suitable communication interface.

In particular embodiments, bus 512 includes hardware, software, or both coupling components of the computational device 500 to each other. As an example and not by way of limitation, bus 512 may include an Accelerated Graphics Port (AGP) or other graphics bus, an Enhanced Industry Standard Architecture (EISA) bus, a front-side bus (FSB), an HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, particular embodiments may include any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Additionally, although this disclosure describes or illustrates particular embodiments as providing particular advantages, particular embodiments may provide none, some, or all of these advantages.

While the disclosure is described with respect to the specific examples, it is to be understood that the scope of the disclosure is not limited to these specific examples. Since other modifications and changes varied to fit particular operating requirements, and environments will be apparent to those skilled in the art, the disclosure is not considered limited to the example chosen for purposes of disclosure and covers changes and modifications, that do not constitute departures from the true spirit and scope of this disclosure.

Although the application describes embodiments having specific structural features and/or methodological acts, it is to be understood that the claims are not necessarily limited to the specific features or acts described. Rather, the specific features and acts are merely illustrative of some embodiments that fall within the scope of the claims of the application.

What is claimed:

1. A method for determining a state of a system comprising a plurality of nodes, the method comprising:
organizing the plurality of nodes into a plurality of clusters, wherein each cluster of the plurality of clusters comprises at least one node;
receiving by each cluster of the plurality of clusters a status request;
determining, by each cluster, after receiving the status request, a status from each node of the at least one node, wherein the status reflects a consensus state of each node of the at least one node;
using, by each cluster, a consensus algorithm to determine a current status of a particular cluster based on the status of each of the at least one node associated with the particular cluster;
reporting the current status of the particular cluster to a control plane of the system;
using, by the control plane, a second consensus algorithm to determine the state of the system based on the current status received from each cluster of the plurality of clusters; and
indicating to a user the state of the system.

2. The method of claim 1, wherein the at least one node comprises three or more nodes.

3. The method of claim 1, wherein the consensus state of each node is determined by determining a state of each of one or more conditions and applying a third consensus algorithm to determine a status of each node.

4. The method of claim 3, wherein the state of each of the one or more conditions is determined by:
periodically obtaining a current state of each of the one or more conditions of each node,
applying a counter that is incremented each time a state change occurs in a particular condition of the one or more conditions of each node, and
setting the state of the particular condition to the current state of the particular condition when the counter is less than a threshold number, after a preset amount of time.

5. The method of claim 4, wherein after the preset amount of time when the counter is greater than or equal to a threshold number, the particular condition is placed in an exponential back-off state for a second preset amount of time.

6. The method of claim 1, wherein the plurality of clusters are organized into at least one workload cluster, and a consensus algorithm is used to determine a current status of a particular workload cluster based on the status of each of the clusters associated with the particular workload cluster, and the current status of the particular workload cluster is reported to the control plane instead of the status of each of the associated clusters.

7. The method of claim 1, wherein each of the plurality of nodes are edge nodes of a distributed computing system.

8. A system, comprising:
a plurality of nodes; and
a server, the server comprising:
one or more processors; and
one or more computer-readable non-transitory storage media coupled to the one or more processors that stores instructions operable when executed by the one or more processors to cause the system to perform a method for determining a state of the system comprising:
organizing the plurality of nodes into a plurality of clusters, wherein each cluster of the plurality of clusters comprises at least one node;
receiving by each cluster of the plurality of clusters a status request;
determining, by each cluster, after receiving the status request, a status from each node of the at least one node, wherein the status reflects a consensus state of each node of the at least one node;
using, by each cluster, a consensus algorithm to determine a current status of a particular cluster based on the status of each of the at least one node associated with the particular cluster;
reporting the current status of the particular cluster to a control plane of the system;
using, by the control plane, a second consensus algorithm to determine a state of the system based on the current status received from each cluster of the plurality of clusters, wherein the system comprises the plurality of nodes; and
indicating to a user the determined state of the system.

9. The system of claim 8, wherein the at least one node comprises three or more nodes.

10. The system of claim 8, wherein the consensus state of each node is determined by determining a state of each of one or more conditions and applying a third consensus algorithm to determine a status of each node.

11. The system of claim 10, wherein the state of each of the one or more conditions is determined by:
periodically obtaining a current state of each of the one or more conditions of each node;
applying a counter that is incremented each time a state change occurs in a particular condition of the one or more conditions of each node; and
setting the state of the particular condition to the current state of the particular condition when the counter is less than a threshold number, after a preset amount of time.

12. The system of claim 11, wherein after the preset amount of time when the counter is greater than or equal to a threshold number the particular condition is placed in an exponential back-off state for a second preset amount of time.

13. The system of claim 8, wherein the plurality of clusters are organized into at least one workload cluster, and a consensus algorithm is used to determine a current status of a particular workload cluster based on the status of each of the clusters associated with the particular workload cluster, and the current status of the particular workload cluster is reported to the control plane instead of the status of each of the associated clusters.

14. The system of claim 8, wherein each of the plurality of nodes are edge nodes of a distributed computing system.

15. At least one non-transitory computer-readable storage medium having stored therein instructions which, when executed by one or more processors, cause the one or more processors to:
organize a plurality of nodes into a plurality of clusters, wherein each cluster of the plurality of clusters comprises at least one node;
receive by each cluster of the plurality of clusters a status request;
determine, by each cluster, after receiving the status request, a status from each node of the at least one node, wherein the status reflects a consensus state of each node of the at least one node;
use, by each cluster, a consensus algorithm to determine a current status of a particular cluster based on the status of each of the at least one node associated with the particular cluster;
report the current status of the particular cluster to a control plane;
use, by the control plane, a second consensus algorithm to determine a state of a system based on the current status received from each cluster of the plurality of clusters, wherein the system comprises the plurality of nodes; and
indicate to a user the determined state of the system.

16. The non-transitory computer-readable storage medium of claim 15, wherein the at least one node comprises three or more nodes.

17. The non-transitory computer-readable storage medium of claim 15, wherein the consensus state of each node is determined by determining a state of each of one or more conditions and applying a third consensus algorithm to determine a status of each node.

18. The non-transitory computer-readable storage medium of claim 17, wherein the state of each of the one or more conditions is determined by:
periodically obtaining a current state of each of the one or more conditions of each node;
applying a counter that is incremented each time a state change occurs in a particular condition of the one or more conditions of each node; and
setting the state of the particular condition to the current state of the particular condition when the counter is less than a threshold number, after a preset amount of time.

19. The non-transitory computer-readable storage medium of claim 18, wherein after the preset amount of time when the counter is greater than or equal to a threshold number the particular condition is placed in an exponential back-off state for a second preset amount of time.

20. The non-transitory computer-readable storage medium of claim 15, wherein the plurality of clusters are organized into at least one workload cluster, and a consensus algorithm is used to determine a current status of a particular workload cluster based on the status of each of the clusters associated with the particular workload cluster, and the current status of the particular workload cluster is reported to the control plane instead of the status of each of the associated clusters.
